(19) United States
(12) Patent Application Publication
(10) Pub. No.: US 2020/0371133 A1
(43) Pub. Date: Nov. 26, 2020

(54) MULTI-SPEED METER CAPABLE OF PERFORMING WIND SPEED MEASUREMENT HAVING SELF-CORRECTION FUNCTION, WIND SPEED MEASUREMENT METHOD HAVING SELF-CORRECTION FUNCTION, AND TRAVELING OBJECT HAVING MULTI-SPEED METER INSTALLED THEREIN

(71) Applicant: KOREA AEROSPACE RESEARCH INSTITUTE, Daejeon (KR)

(72) Inventors: Byeong Hee CHANG, Daejeon (KR); Young Min PARK, Daejeon (KR); Chang Ho LEE, Daejeon (KR)

(21) Appl. No.: 16/640,048

(22) PCT Filed: Aug. 17, 2018
(86) PCT No.: PCT/KR2018/009429

§ 371 Date: Aug. 7, 2020

(30) Foreign Application Priority Data
Aug. 17, 2017 (KR) 10-2017-0104242

(51) Int. Cl. G01P 21/02; G01P 5/14; G01P 3/42; G01P 15/14

(52) U.S. Cl. CPC G01P 21/025; G01P 15/14; G01P 3/42; G01P 5/14

(57) ABSTRACT

The present invention relates to: a multi-speed meter capable of measuring a wind speed with a self-correction function, a wind speed measuring method with a self-correction function, and a moving apparatus having a multi-speed meter installed therein, which are installed on a ground-based moving apparatus significantly affected by a wind speed such as a bicycle or motorcycle to measure a wind speed and simultaneously correct a displayed speed. The multi-speed meter capable of measuring a wind speed with a self-correction function includes an absolute speedometer installed on a moving apparatus and measuring an absolute speed, a relative speedometer installed on the moving apparatus and measure a relative speed of the traveling object; and a control unit which receives and outputs the absolute speed and the relative speed respectively measured by the absolute speedometer and the relative speedometer, and outputs a wind speed which is the difference between the absolute speed and the relative speed.

### CROSS-REFERENCE TO RELATED APPLICATIONS

The present application is a U.S. National Phase of International Patent Application Serial No. PCT/KR2018/009429 entitled “MULTI-SPEED METER CAPABLE OF PERFORMING WIND SPEED MEASUREMENT HAVING SELFCORRECTION FUNCTION, WIND SPEED MEASUREMENT METHOD HAVING SELF-CORRECTION FUNCTION, AND TRAVELING OBJECT HAVING MULTI-SPEED METER INSTALLED THEREIN,” filed on Aug. 17, 2018. International Patent Application Serial No. PCT/KR2018/009429 claims priority to Korean Patent Application No. 10-2017-0104242 filed on Aug. 17, 2017. The entire contents of each of the above-referenced applications are hereby incorporated by reference for all purposes.

### TECHNICAL FIELD

The present invention relates a multi-speed meter capable of measuring a wind speed with a self-correction function, a wind speed measuring method with a self-correction function, and a moving apparatus having a multi-speed meter installed therein, and more particularly, to a multi-speed meter capable of measuring a wind speed with a self-correction function, which is installed on a ground-based moving apparatus significantly affected by a wind speed such as a bicycle or motorcycle to measure a wind speed and correct a wind speed that may occur due to an occupant, a wind speed measuring method with a self-correction function, and a moving apparatus having a multi-speed meter installed therein.

### BACKGROUND ART

A ground-based moving apparatus such as a car or motorcycle is equipped with a separate speedometer to guide a speed of the ground-based moving apparatus to a driver. Unlike cars or motorcycles, ground-based moving apparatus, such as bicycles without a separate internal combustion engine or system, may have a sensor attached to a side of a wheel to measure a magnetic field and a magnet attached to the wheel or a fork to calculate a speed of the ground-based moving apparatus by measuring a speed at which a magnetic field is converted by a magnetic sensor or to measure the speed of the ground-based moving apparatus using a global positioning system (GPS) in an application installed in a mobile phone, which is a user's option, though.

An RPM speedometer and a GPS speedometer for measuring a rotational speed of the wheel described above are disclosed in Korean Patent Laid-Open Publication No. 10-2009-0109247 (“Speed indicator for correcting error and method thereof” published on Oct. 20, 2009, Related Art 1). Both the RPM speedometer and the GPS speedometer disclosed in Related Art 1 measure an absolute speed of a moving apparatus, and the absolute speed measured in this way is problematic in that it does not consider a wind pressure acting on a driver due to wind when the driver is exposed to the outside such as a bicycle or a motorcycle among ground-based moving apparatus.

Meanwhile, in an aircraft, a relative speed is measured using a pressure speedometer. Since the pressure speedometer measures a total pressure and a static pressure and then calculates the relative speed of the aircraft using a difference between the total pressure and the static pressure, a wind pressure acting on the aircraft is considered.

The aircraft using the pressure speedometer may obtain an accurate relative speed because distortion of the total pressure and static pressure is not large, but in the case of the ground-based moving apparatus, in particular, a bicycle or motorcycle, a relative speed measured by the pressure speedometer includes an error due to different outer appearances based on accessories such as a bag attached to a body of the ground-based moving apparatus or a posture of an occupant. Therefore, the measured relative speed needs to be corrected to apply the pressure speedometer to the ground-based moving apparatus such as a bicycle or motorcycle.

### DISCLOSURE

### Technical Problem

An object of the present invention is to provide a multi-speed meter capable of measuring a wind speed with a self-correction function, a wind speed measuring method with a self-correction function, and a moving apparatus having a multi-speed meter installed therein, which are installed on a ground-based moving apparatus such as a bicycle or a motorcycle in which a driver is exposed to the outside to provide information such as an absolute speed, a relative speed, and a wind speed to the driver and which are capable of correcting the relative speed considering distortion that may occur in the bicycle or the motorcycle.

### Technical Solution

In one general aspect, a multi-speed meter capable of measuring a wind speed with a self-correction function includes: an absolute speedometer installed on a moving apparatus and measuring an absolute speed; a relative speedometer installed on the moving apparatus and measuring a relative speed; and a controller outputting the measured absolute speed and the relative speed transmitted from the absolute speedometer and the relative speedometer and outputting a wind speed which is a difference between the absolute speed and the relative speed.

The controller may derive a correction equation using a relationship between an absolute speed and a relative speed measured during a predetermined time in which the moving apparatus travels in an environment where wind does not blow, and output a relative speed corrected using the correction equation and a wind speed.

The absolute speedometer may include at least one selected from among an RPM speedometer, a GPS speedometer, a gyro sensor, and an acceleration sensor.

The controller may selectively output an absolute speed measured by each speedometer or sensor or output an average of all measured absolute speeds, when the absolute speedometer includes two or more of the RPM speedometer, the GPS speedometer, the gyro sensor, and the acceleration sensor.

The relative speedometer may be a pressure speedometer or an ultrasonic speedometer.

The relative speedometer may be integrated with the controller or may be separately installed on the moving apparatus.

The GPS speedometer may be integrated with the controller or separately installed on the moving apparatus, when the GPS speedometer is included in the absolute speedometer.

The pressure speedometer may include: a total pressure measuring unit installed toward a front of the moving apparatus to measure a total pressure; and a static pressure measuring unit installed on a side of the total pressure measuring unit.

The multi-speed meter may further include: a multi-speed meter body including the controller and an output unit outputting information received from the controller.

The multi-speed meter body may be a smart device.

In another general aspect, a wind speed measuring method with a self-correction function includes: an absolute speed measuring operation of measuring an absolute speed of a moving apparatus; a relative speed measuring operation of measuring a relative speed of the moving apparatus with wind around the moving apparatus; and a wind speed outputting operation of outputting a wind speed which is a difference between the absolute speed measured in the absolute speed measuring operation and the relative speed measured in the relative speed measuring operation.

The wind speed measuring method may further include: an absolute speed and relative speed outputting operation of outputting the absolute speed and the relative speed measured in the absolute speed measuring operation and the relative speed measuring operation, respectively, the absolute speed and relative speed outputting operation being performed after the absolute speed measuring operation and the relative speed measuring operation.

The wind speed outputting operation may include deriving a correction equation using a relationship between an absolute speed and a relative speed measured during a predetermined time in which the moving apparatus travels in an environment where wind does not blow, and outputting a relative speed corrected using the correction equation and a wind speed.

The multi-speed meter capable of measuring a wind speed with a self-correction function may be installed on a moving apparatus, and the moving apparatus may be a bicycle, a motorcycle, or a personal mobility device.

### Advantageous Effects

According to the multi-speed meter capable of measuring a wind speed with a self-correction function, a wind speed measuring method with a self-correction function, and a moving apparatus having a multi-speed meter installed therein according to various exemplary embodiments of the present invention, since an absolute speed and a relative speed are measured by the absolute speedometer and the relative speedometer measure, respectively, and a wind speed is calculated using a difference between the two speeds, a driver of a moving apparatus such as a bicycle, a motorcycle, or a personal mobility device in which a driver is exposed to the outside may easily adjust a speed and a pace of the moving apparatus according to a wind speed.

In addition, according to the present invention, in order to correct a distorted relative speed according to an external shape (appearance), a correction equation of an absolute speed and the relative speed while a moving apparatus travels in an environment without wind is obtained, and a corrected relative speed and a wind speed are then measured using the obtained correction equation in a real-usage environment, thereby providing a more accurate wind speed to the driver.

### BRIEF DESCRIPTION OF THE DRAWINGS

FIG. 1 is a perspective view of a bicycle in which one exemplary embodiment of the present invention is installed.

FIG. 2 is a partially enlarged view of FIG. 1.

FIG. 3 is an enlarged view of another portion of FIG. 1.

FIG. 4 is a perspective view of another exemplary embodiment of a pressure speedometer of the present invention.

FIG. 5 is a schematic view illustrating a difference between an absolute speed and a relative speed according to a wind direction.

FIG. 6 is a schematic view of a feasible exemplary embodiment of the present invention.

FIG. 7 is a graph of an absolute speed and a relative speed measured after traveling in a room.

FIGS. 8 and 9 are graphs of an absolute speed, a relative speed, and a wind speed measured after traveling outdoors in different conditions.

### BEST MODE

Hereinafter, exemplary embodiments of a multi-speed meter capable of measuring a wind speed with a self-correction function according to the present invention will be described in detail with reference to the accompanying drawings.

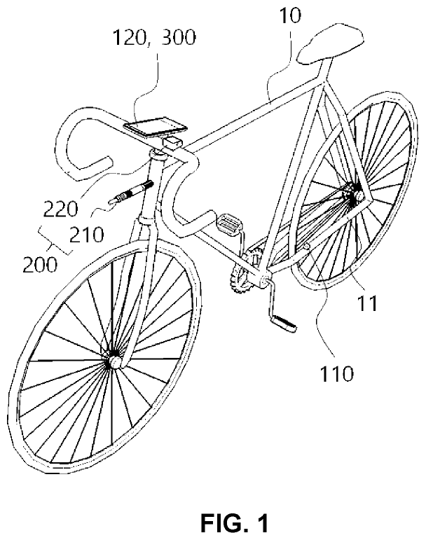

FIG. 1 schematically shows a bicycle equipped with one exemplary embodiment of a multi-speed meter capable of measuring a wind speed with a self-correction function according to the present invention. As shown in FIG. 1 one exemplary embodiment of the multi-speed meter capable of measuring a wind speed with a self-correction function may include an absolute speedometer, a relative speedometer, and a controller.

As shown in FIG. 1, the absolute speedometer is installed on a moving apparatus such as a bicycle 10 to measure an absolute speed of the moving apparatus. The absolute speedometer may include an RPM speedometer or a GPS speedometer as described above in the background, and alternatively, the absolute speedometer may include a single gyro sensor or an acceleration sensor, or a combination of the gyro sensor and the acceleration sensor, which is capable of measuring an absolute speed. In addition, the moving apparatus described above may be a personal mobility device such as a motorcycle, an electric wheel, an electric kick board, an electric skateboard, an electric bicycle, or the like, in which the driver is exposed to the outside, as well as the bicycle 10 shown in FIG. 1.

In addition, various absolute speedometers such as the RPM speedometer, the GPS speedometer, the gyro sensor, or the acceleration sensor described above may be used independently alone or a combination of a plurality thereof may also be used. In one exemplary embodiment of the present invention illustrated in FIG. 1, the RPM speedometer and the GPS speedometer are used together and an average of absolute speeds respectively measured by the RPM speedometer and the GPS speedometer may be used.

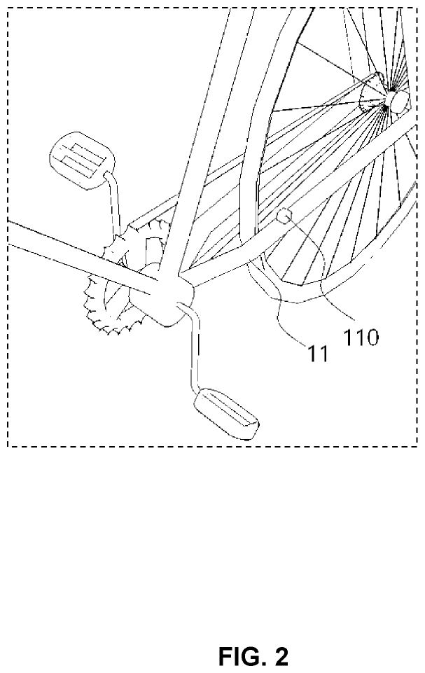

The RPM speedometer may be implemented in various ways. In the present invention, the RPM speedometer may include a magnetic sensor 110 installed on a chain stay 11 located at a rear of a frame of a bicycle to measure a change in a magnetic field and a magnet (not shown) installed on a wheel or a fork as shown in FIGS. 1 and 2, and a GPS speedometer 120 may be installed on a handle of the bicycle and implemented in an application form in a smart device 300 having a display.

An absolute speed of the moving apparatus measured in the RPM speedometer and GPS speedometer, i.e., the absolute speed of the bicycle 10, is transmitted to a controller to be described later, and the RPM speedometer and GPS speedometer may include various wireless communication units such as ZigBee or Bluetooth or may be connected to the controller through wires to transmit the measured absolute speed of the moving apparatus to the controller.

A relative speedometer measures a relative speed of the moving apparatus with wind blowing around the moving apparatus.

The relative speedometer measures the relative speed of the moving apparatus with wind blowing around the moving apparatus in various ways, and a representative method of the relative speedometer may include a pressure speedometer 200 illustrated in FIG. 1 and there may be an ultrasonic speedometer in addition.

The pressure speedometer 200 is installed on the moving apparatus to measure the relative speed of the moving apparatus and includes a total pressure measuring unit 210 installed toward a front of the moving apparatus to measure a total pressure and a static pressure measuring unit 220 installed on a side of the total pressure measuring unit 210 to measure a static pressure.

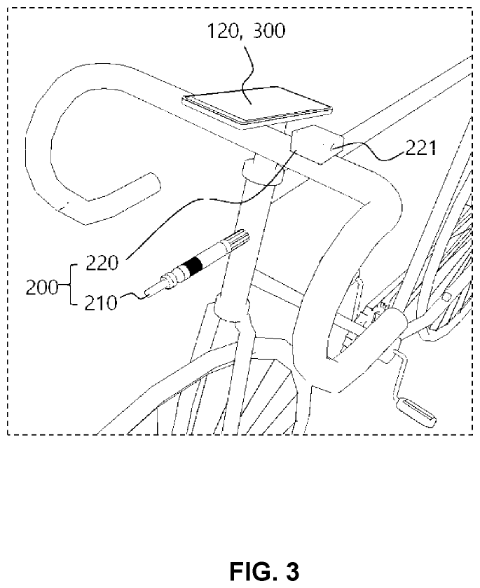

The total pressure measuring unit 210 serves to measure a total pressure which is a pressure received from air as the bicycle 10 travels. The total pressure measuring unit 210 may be installed in the form of a probe so that a total pressure hole (not shown) faces forward as shown in FIGS. 1 and 3. The reason that the total pressure measuring unit 210 is formed to protrude toward the front of the bicycle 10 in the form of a probe is to prevent a phenomenon in which a speed of air around the bicycle or the driver is reduced to distort an air pressure. The probe-shaped total pressure measuring unit 210 has the advantage of accurately measuring a total pressure as described above but the shape of the total pressure measuring unit 210 in the present invention is not limited to the probe shape illustrated in FIGS. 1 and 3 and the total pressure measuring unit 210 may have any shape as long as it can measure a total pressure while the moving apparatus is traveling.

The static pressure measured by the static pressure measuring unit 220 refers to a pressure when there is no flow of a fluid or without considering a flow of a fluid, and is determined by temperature and air density. It is important for the static pressure measuring unit 220 itself to be installed on a portion where an influence of external air is minimized, and to this end, as shown in FIGS. 1 and 3, the static pressure measuring unit 220 may be installed such that a static opening 221 faces a direction perpendicular to a moving direction of the bicycle 10, i.e., faces a side of the moving apparatus in the moving direction.

As shown in FIG. 3, the static pressure measuring unit 220 may include a display on an upper surface thereof and may be installed on a position that can be easily identified by an occupant of the ground-based moving apparatus such as a handle of the bicycle. A relative speed measured by the total pressure measuring unit 210 and the static pressure measuring unit 220 may be displayed on the display included in the static pressure measuring unit 220.

Only a single static pressure measuring unit 220 may not be installed but a plurality of static pressure measuring units 220 may be installed around the bicycle 10 to increase precision of the measured static pressure. For example, the static pressure measuring unit 220 may be installed on both sides of the bicycle in the moving direction of the bicycle 10.

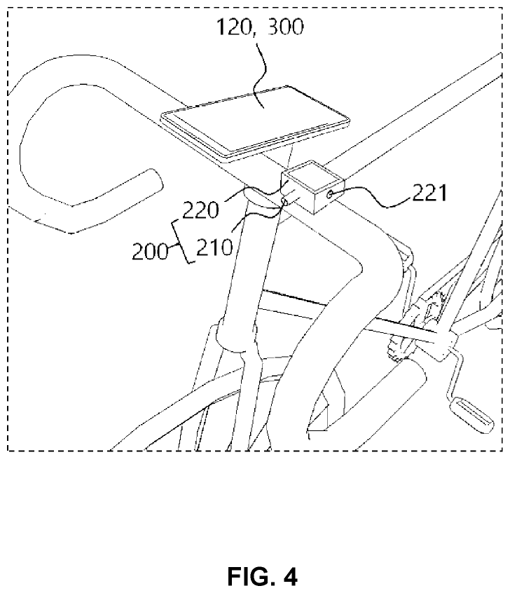

FIG. 4 shows another exemplary embodiment of the pressure speedometer 200. In the pressure speedometer 200 shown in FIG. 4, the total pressure measuring unit 210 and the static pressure measuring unit 220 are integrally formed with each other, and the total pressure measuring unit 210 is a tube type instead of a probe type. In addition, the total pressure measuring unit 210 may have a form of a total pressure hole like the static opening 221.

The ultrasonic speedometer is a speedometer to measure a speed using a passage time of an ultrasonic wave and uses a principle that the passage time of the ultrasonic wave is faster than a reference time if a moving direction of the ultrasonic wave is the same as that of air and the passage time of the ultrasonic wave is slower than the reference time if the moving direction of the ultrasonic wave is the opposite to the moving direction of air.

The ultrasonic speedometer includes a pair of members for transmitting and receiving an ultrasonic wave or transmitting, reflecting, and receiving an ultrasonic wave. The pair of members are arranged to surround a specific space to measure a wind direction and a wind speed through a vector sum of each speed. When the ultrasonic speedometer is installed as a relative speedometer at the ground-based moving apparatus as in the present invention, a relative speed of the moving apparatus with ambient wind may be measured.

Although the pressure speedometer 200 and the ultrasonic speedometer as the relative speedometer described above may be used independently, or alternatively, the pressure speedometer 200 and the ultrasonic speedometer may be used together and an average of relative speeds measured by the pressure speedometer 200 and the ultrasonic speedometer may be used to increase accuracy of the measured relative speeds.

The controller (not shown) receives the absolute speed and the relative speed respectively measured by the absolute speedometer and the relative speedometer 200 and outputs them as they are or performs a predetermined correction thereon and outputs corrected speeds. In addition, the controller may obtain a difference between the absolute speed and the relative speed of the moving apparatus and output the difference as a wind speed.

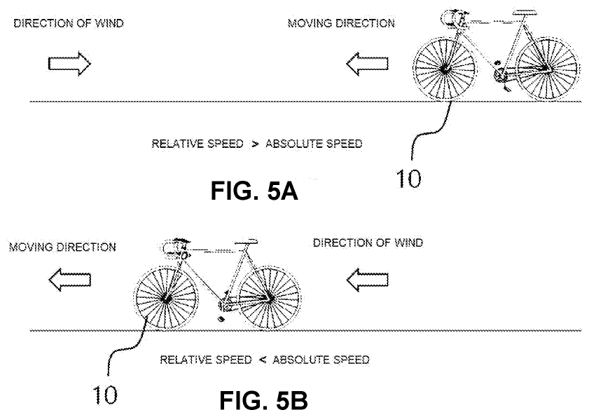

FIG. 5 schematically illustrates a case where a relative speed is greater than an absolute speed and a case where the relative speed is smaller than the absolute speed to explain a case where there is a difference between an absolute speed and a relative speed due to a direction of wind. FIG. 5(A) shows a case where wind blows in a direction opposite to a traveling direction of the bicycle 10. As shown in FIG. 5(A), when wind blows in the direction opposite to the traveling direction of the bicycle 10, the relative speed acting on the bicycle 10 is greater than the absolute speed of the bicycle, pressure of air flowing into the total pressure measuring unit installed on the front, specifically, the total pressure hole of the total pressure measuring unit, increases.

FIG. 5(B) shows a case where wind blows in the same direction as the moving direction of the bicycle 10. As shown in FIG. 5(B), when wind blows in the same direction as the traveling direction of the bicycle 10, a relative speed acting on the bicycle 10 is lower than an absolute speed and pressure of air flowing into the total pressure hole of the total pressure measuring unit installed on the front is lowered. In this case, a difference between the relative speed and the absolute speed may be a wind speed, and whether the wind is a head wind or a tail wind may be determined and a wind speed may be calculated in each of the cases of FIGS. 5A and 5B.

The controller may be implemented in the form of a program inside the multi-speed meter main body. In addition to the controller, the multi-speed meter main body may further include an output unit for outputting information (absolute speed, relative speed, wind speed) received from the controller. The output unit may be typically a display but various types of output units capable of transmitting information to the driver of the ground-based moving apparatus such as a voice output unit may be used.

Since the multi-speed meter main body only needs to include the controller and the output unit, any device including an MCU may be used. For example, a smart device 300 shown in FIGS. 1 and 3 may be the main body of the multi-speed meter, and the static pressure measuring unit 220 may also be a main body of the multi-speed meter if the static pressure measuring unit 220 includes an output unit such as a display and a controller implemented in the form of a program.

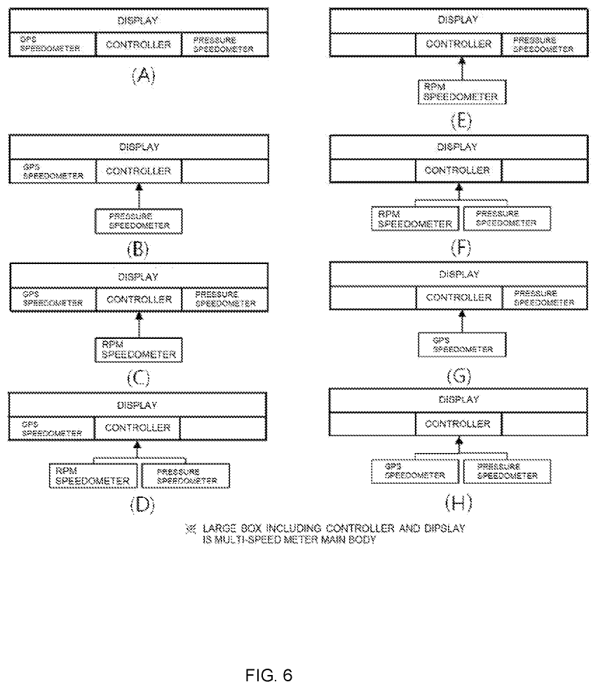

FIG. 6 schematically illustrates how a GPS speedometer, an RPM speedometer, a pressure speedometer, a controller, and a display configuring the absolute speedometer are configured. FIG. 6 illustrates a case where the absolute speedometer includes a single GPS speedometer or a single RPM speedometer or a combination thereof and a case where the pressure speedometer is integrally configured or separately configured. In FIG. 6, the largest box including the controller and the display is the multi-speed meter main body.

Referring to FIG. 6, specifically, FIG. 6A shows an exemplary embodiment in which the absolute speedometer includes only the GPS speedometer, and the GPS speedometer, the controller, and the pressure speedometer are integrated in the multi-speedometer main body. FIG. 6B shows an exemplary embodiment in which the absolute speedometer includes only the GPS speedometer, the GPS speedometer and the controller are integrated in the multi-speedometer main body, and a pressure speedometer is separately installed. FIG. 6C shows an exemplary embodiment in which the absolute speedometer includes the GPS speedometer and the RPM speedometer, the GPS speedometer, the controller, and the pressure speedometer are integrated in the multi-speed main body, and the PRM speedometer is configured to be separated from the integrated device. The RPM speedometer measures a speed of the moving apparatus by measuring an RPM of a wheel, and thus, the RPM speedometer needs to be installed adjacent to the wheel. Therefore, the RPM speedometer may not be integrated in the multi-speed meter main body which is installed at a handle to provide information to the user, and may transmit a measured speed to the multi-speed meter main body.

FIG. 6D shows an exemplary embodiment in which the absolute speedometer includes the GPS speedometer and the RPM speedometer, the GPS speedometer and the controller are integrated in the multi-speed meter main body, and the RPM speedometer and the pressure speedometer are separately configured. FIG. 6E shows an exemplary embodiment in which the absolute speedometer includes only the RPM speedometer, and the controller and the pressure speedometer are integrated in the multi-speed meter main body. FIG. 6F shows an exemplary embodiment in which only the controller is only provided in the multi-speed meter main body, and the RPM speedometer and the pressure speedometer separately installed outside transmit a measured speed to the multi-speed meter main body.

FIGS. 6G and 6H show exemplary embodiments in which the absolute speedometer includes the GPS speedometer and is separated from the multi-speed meter main body. In FIGS. 6G and 6H, the pressure speedometer is integrated in the multi-speed meter main body or is separately configured.

The multi-speed meter main body described above may be replaced by a smart device equipped with a necessary program.

As described above in the background, when the driver applies the pressure speedometer to the ground-based moving apparatus such as a bicycle or a motorcycle in which the driver is exposed to the outside, a total pressure and a static pressure are significantly distorted due to a non-uniform shape of the ground-based moving apparatus, and thus, the total pressure and the static pressure need to be corrected. Test traveling for correction may be performed for a predetermined time, and a separate button for determining ON/OFF of the test traveling for correction may be implemented as a mechanical button or a touch screen at the multi-speed meter main body or as a touch screen at the smart device 300 and installed on the bicycle.

The test traveling for correction may be conducted in an environment in which a wind speed needs not be considered, that is, in an environment where wind does not blow.

First in a wind-free environment, the driver rides on the bicycle equipped with the multi-speed meter capable of measuring a wind speed with a self-correction function based on the present invention, presses an ON button of the test traveling, and then slowly accelerates to a maximum speed in a stop state, while keeping a steady posture. Since wind does not blow in the traveling environment, an absolute speed and a relative speed measured by the absolute speedometer and the relative speedometer should be the same but distortion occurs due to the shape of the bicycle and the driver. In this case, it is considered that the distortion has occurred in the relative speed measured by the relative speedometer, and a relational expression between the absolute speed measured up to a maximum speed based on the absolute speed as a constant and the relative speed is derived. As the relational expression, a method such as a linear correction formula using a least square method and a multi-order function correction formula may be used due to a curve fitting problem based on data of the absolute speed and relative speed.

Specifically, m data sets of absolute speeds (yi) and relative speeds (xi) may be expressed by the least square method of (n−1)-th order polynomial as follows.

$${\sum }_{j = 1}^{n} {X}_{ij} {B}_{j} = {y}_{j} , ( i = 1 , 2 , … , m ) ,$$

In the above formula, Xij is a polynomial j term of an i-th relative speed and Xi1=1, Xi2=xi, Xi3=xî2, Xin=xîn−1, and Bj is a coefficient of j term of the (n−1)-th order correction formula, and a determinant thereof is as follows.

$$X = [ \begin{matrix}{X}_{11} & {X}_{12} & ⋯ & {X}_{1 n} \\ {X}_{21} & {X}_{22} & ⋯ & {X}_{2 n} \\ ⋮ & ⋮ & ⋱ & ⋮ \\ {X}_{m 1} & {X}_{m 2} & ⋯ & {X}_{mn}\end{matrix} ] , β = [ \begin{matrix}{β}_{1} \\ {β}_{2} \\ ⋮ \\ {β}_{n}\end{matrix} ] , y = [ \begin{matrix}{y}_{1} \\ {y}_{2} \\ ⋮ \\ {y}_{n}\end{matrix} ] ,$$

If n>m in the above formula, there is no solution, if n=m, there is only one solution, and if n<m, there is no solution that satisfies all data but the coefficient Bj of the polynomial that minimizes the square of an error is obtained as follows.

\hat{β}=(X^{T}X)⁻¹ X^{T}y.

In order to apply the corrected equation to the relative speed measurement in traveling, the order (n−1) of correction equation or correction test data set (m) need to be determined so as to satisfy the condition of n<m.

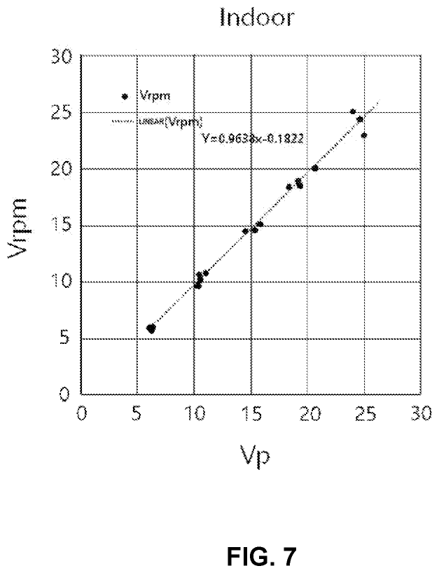

FIG. 7 is a graph of numerical values obtained by actually performing the above process, in which the y-axis represents the measured absolute speed, the x-axis represents the measured relative speed. A relational expression such as y=0.9638x−0.1822 was derived by correcting the actually measured relative speed based on y=ax+b which is a linear equation (n=2). After the test traveling is turned off, the obtained relational expression may be stored and utilized to correct a relative speed during traveling afterward. However, the least square method is an example of correction of the relative speed using the absolute speed, and the present invention is not limited thereto and various methods such as a trigonometric function, Gaussian, Lorentzian, Voigt function, and the like may also be applied as the curve fitting method for the correction formula, in addition to the least square method.

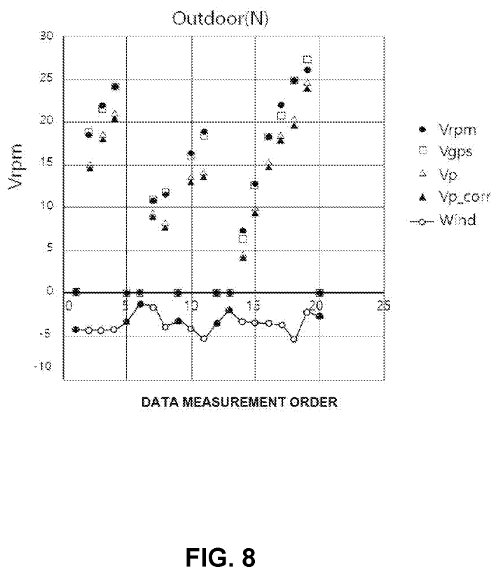

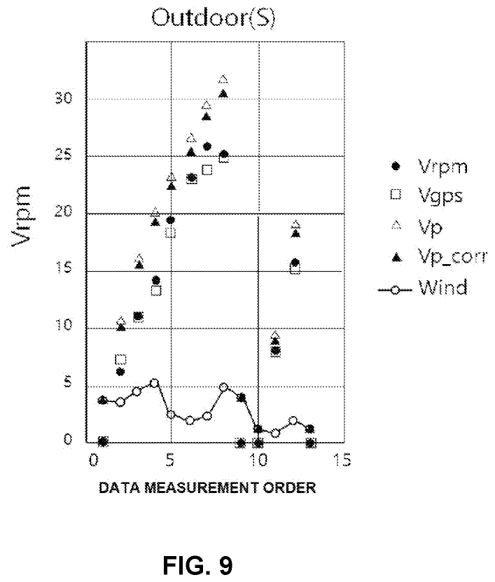

FIG. 8 is a graph obtained by measuring a speed at every unit time interval, while traveling from the south to the north in a predetermined route of north-south direction, and FIG. 9 is a graph obtained by measuring a speed at every unit time interval, while traveling from the north to the south in the same route as that of FIG. 8.

Since the measured relative speed Vp includes distortion due to the appearance of the moving apparatus body and the driver, the measured relative speed is corrected using the relational expression derived from the wind-free environment. FIGS. 8 and 9 show the corrected relative speed Vp_corr and a wind speed. In FIG. 8 in which traveling was performed from the south to the north, the relative speed is lower than the absolute speed and a wind speed has a minus value, and in FIG. 9, the relative speed is higher than the absolute speed and a wind speed has a plus value, and thus, it can be seen that wind blows at 0 to 6 km/h from the south to the north.

In FIGS. 8 and 9, traveling was reciprocated in the same route for explanation, but in general, whether current wind is a head wind or a tail wind may be recognized, a wind speed may also be recognized, and a relative speed substantially applied to the driver may be derived through the measured relative speed according to the present invention.

Hereinafter, a wind speed measuring method with a self-correction function according to the present invention will be described in detail.

The wind speed measuring method with a self-correction function according to an exemplary embodiment of the present invention may include an absolute speed measurement step, a relative speed measurement step, and a wind speed output step.

The absolute speed measurement step is to measure an absolute speed of a moving apparatus. The absolute speed measurement step may be performed by an absolute speedometer installed on the moving apparatus included in the multi-speed meter described above.

The relative speed measurement step is to measure a relative speed of the moving apparatus with wind around the moving apparatus. The relative speed measurement step may be performed by a relative speedometer installed on the moving apparatus included in the multi-speedometer described above.

The wind speed output step is to output a wind speed which is a difference between the absolute speed measured in the absolute speed measurement step and the relative speed measured in the absolute speed measurement step. The wind speed output step may be performed by a controller installed on the moving apparatus included in the multi-speed meter described above.

The present invention may further include an absolute speed and a relative speed output step in addition to the three steps described above. That is, in the present invention, the controller may not simply output the wind speed in the wind speed output step but may also output an absolute speed and a relative speed, thereby providing the absolute speed, the relative speed, and the wind speed of the moving apparatus as information required for the operation to the driver of the moving apparatus.

The wind speed output in the wind speed output step may be a corrected speed. This is because the measured wind speed may be distorted as the driver of the moving apparatus such as a bicycle, a motorcycle, a personal mobility device is exposed to the outside and due to an appearance varied depending on various accessories installed on the moving apparatus.

The specific method for correcting the wind speed in the wind speed output step may be a method of deriving a correction formula using a relation between the absolute speed and the relative speed measured for a predetermined time in which the moving apparatus travels in an environment without wind, and outputting the corrected relative speed and the wind speed using the correction formula.

It will be obvious to those skilled in the art to which the present invention pertains that the present invention described above is not limited to the above-mentioned exemplary embodiments and the accompanying drawings, but may be variously substituted, modified, and altered without departing from the scope and spirit of the present invention.

### DETAILED DESCRIPTION OF MAIN ELEMENTS

10: bicycle
11: chain stay
110: magnetic sensor
120: GPS speedometer
200: pressure speedometer
210: total pressure measurement unit
220: static pressure measuring unit
221: static opening
300: smart device

1. A multi-speed meter capable of measuring a wind speed with a self-correction function, the multi-speed meter comprising:
an absolute speedometer installed on a moving apparatus and measuring an absolute speed;
a relative speedometer installed on the moving apparatus and measuring a relative speed; and
a controller outputting the measured absolute speed and the relative speed transmitted from the absolute speedometer and the relative speedometer and outputting a wind speed which is a difference between the absolute speed and the relative speed.

2. The multi-speed meter of claim 1, wherein the controller derives a correction equation using a relationship between an absolute speed and a relative speed measured during a predetermined time in which the moving apparatus travels in an environment where wind does not blow, and outputs a relative speed corrected using the correction equation and a wind speed.

3. The multi-speed meter of claim 1, wherein the absolute speedometer comprises at least one selected from among an RPM speedometer, a GPS speedometer, a gyro sensor, and an acceleration sensor.

4. The multi-speed meter of claim 3, wherein the controller selectively outputs an absolute speed measured by each speedometer or sensor or outputs an average of all measured absolute speeds, when the absolute speedometer comprises two or more of the RPM speedometer, the GPS speedometer, the gyro sensor, and the acceleration sensor.

5. The multi-speed meter of claim 1, wherein the relative speedometer is a pressure speedometer or an ultrasonic speedometer.

6. The multi-speed meter of claim 1, wherein the relative speedometer is integrated with the controller or is separately installed on the moving apparatus.

7. The multi-speed meter of claim 3, wherein the GPS speedometer is integrated with the controller or separately installed on the moving apparatus, when the GPS speedometer is included in the absolute speedometer.

8. The multi-speed meter of claim 5, wherein the pressure speedometer comprises:
a total pressure measuring unit installed toward a front of the moving apparatus to measure a total pressure; and
a static pressure measuring unit installed on a side of the total pressure measuring unit.

9. The multi-speed meter of claim 1, further comprising a multi-speed meter body including the controller and an output unit outputting information received from the controller.

10. The multi-speed meter of claim 9, wherein the multi-speed meter body is a smart device.

11. A wind speed measuring method with a self-correction function, the wind speed measuring method comprising:
an absolute speed measuring operation of measuring an absolute speed of a moving apparatus;
a relative speed measuring operation of measuring a relative speed of the moving apparatus with wind around the moving apparatus; and
a wind speed outputting operation of outputting a wind speed which is a difference between the absolute speed measured in the absolute speed measuring operation and the relative speed measured in the relative speed measuring operation.

12. The wind speed measuring method of claim 11, further comprising:
an absolute speed and relative speed outputting operation of outputting the absolute speed and the relative speed measured in the absolute speed measuring operation and the relative speed measuring operation, respectively, the absolute speed and relative speed outputting operation being performed after the absolute speed measuring operation and the relative speed measuring operation.

13. The wind speed measuring method of claim 11, wherein the wind speed outputting operation comprises deriving a correction equation using a relationship between an absolute speed and a relative speed measured during a predetermined time in which the moving apparatus travels in an environment where wind does not blow, and outputting a relative speed corrected using the correction equation and a wind speed.

14. The moving apparatus including a multi-speed meter capable of measuring a wind speed with a self-correction function according to one selected from claim 1.

15. The moving apparatus of claim 14, wherein the traveling object is a bicycle, a motorcycle, or a personal mobility device.

16. The moving apparatus including a multi-speed meter capable of measuring a wind speed with a self-correction function according to one selected from claim 11.

17. The moving apparatus of claim 16, wherein the moving apparatus is a bicycle, a motorcycle, or a personal mobility device.
